(19) United States
(12) Patent Application Publication
(10) Pub. No.: US 2024/0128806 A1
(43) Pub. Date: Apr. 18, 2024

(54) STATOR CORE SEGMENT FOR AN AXIAL FLUX ELECTRIC MOTOR

(71) Applicant: GM Global Technology Operations LLC, Detroit, MI (US)

(72) Inventors: Jian Yao, Shanghai (CN); Vincent Fedida, Shanghai (CN); Chengwu Duan, Shanghai (CN); Alan G. Holmes, Clarkston, MI (US)

(21) Appl. No.: 17/976,029

(22) Filed: Oct. 28, 2022

(30) Foreign Application Priority Data
Oct. 12, 2022 (CN) 202211248395.8

(51) Int. Cl. H02K 1/14; H02K 21/24

(52) U.S. Cl. CPC H02K 1/146; H02K 21/24

(57) ABSTRACT

A stator core segment for an axial flux electric motor includes a first lamination step having a first length, a first width, and a first thickness, and a second lamination step having a second length, a second width, and a second thickness. At least one of the second length, the second width, and the second thickness is distinct from corresponding ones of the first length, the first width, and the first thickness.

### CROSS-REFERENCE TO RELATED APPLICATIONS

This application claims priority to Chinese Patent Application No. CN202211248395.8, filed Oct. 12, 2022, the contents of which are incorporated by reference herein in their entirety.

### INTRODUCTION

The subject disclosure relates to the art of axial flux electric motors and, more particularly, to a stator core segment for an axial flux electric motor.

Axial flux electric motors include stators that include stator segments that project axially outwardly from a stator support. In some cases, the stator segments and the stator support are formed from a single piece of metal. In other cases, the stator is formed from a plurality of individual core segments that are connected to the stator support and wound by a conductor. The stator segments have a trapezoidal shape.

Stator segments are often molded from a soft magnetic composite (SMC) material. In other cases, the SMC material may be molded about stacked laminations. Regardless of the method used, the stator suffers from spin losses that degrade an overall efficiency of the motor. Further, molding and/or over forming laminations into a trapezoidal shape before over-molding to form a stator segment is a costly process. Accordingly, it is desirable to provide a stator core segment that is readily manufactured and which can reduce operational losses.

### SUMMARY

A stator core segment for an axial flux electric motor in accordance with a non-limiting example includes a first lamination step having a first length, a first width, and a first thickness, and a second lamination step having a second length, a second width, and a second thickness. At least one of the second length, the second width, and the second thickness is distinct from corresponding ones of the first length, the first width, and the first thickness.

In addition to one or more of the features described herein the second width of each of the second lamination step is distinct from the first width of the first lamination step.

In addition to one or more of the features described herein the second width of the second lamination step is smaller than the first width of the first lamination step.

In addition to one or more of the features described herein the first lamination step includes a first lamination step thickness and the second lamination step includes a second laminations step thickness that is similar to the first lamination step thickness.

In addition to one or more of the features described herein a third lamination step has a third length, a third width that is greater than the first width, and a third thickness.

In addition to one or more of the features described herein the third thickness is greater than the first thickness and the second thickness.

In addition to one or more of the features described herein the second lamination step is arranged between the first lamination step and the third lamination step.

In addition to one or more of the features described herein the first lamination step is formed from a first plurality of laminations, the second lamination step is formed from a second plurality of laminations, and the third lamination step is formed from a third plurality of laminations.

In addition to one or more of the features described herein a stator winding extends about each of the first lamination step, the second lamination step, and the third lamination step.

In addition to one or more of the features described herein at least one additional step is formed from a single lamination arranged between the second lamination step and the stator winding.

A vehicle, in accordance with a non-limiting example, includes a body defining a passenger compartment and an axial flux electric motor arranged in the body. The axial flux electric motor includes a housing a rotor rotatably supported in the housing, and a stator fixedly mounted in the housing. The stator includes an annular segment support member having an axially facing surface and a plurality of stator core segments mounted about the axially facing surface. Each of the plurality of stator core segments includes a first lamination step having a first length, a first width, and a first thickness, and a second lamination step having a second length, a second width, and a second thickness. At least one of the second length, the second width, and the second thickness is distinct from corresponding ones of the first length, the first width, and the first thickness.

In addition to one or more of the features described herein the second width of each of the second lamination step is distinct from the first width of the first lamination step.

In addition to one or more of the features described herein the second width of the second lamination step is smaller than the first width of the first lamination step.

In addition to one or more of the features described herein the first lamination step includes a first lamination step thickness and the second lamination step includes a second laminations step thickness that is similar to the first lamination step thickness.

In addition to one or more of the features described herein a third lamination step has a third length, a third width that is greater than the first width, and a third thickness.

In addition to one or more of the features described herein the third thickness is greater than the first thickness and the second thickness.

In addition to one or more of the features described herein the second lamination step is arranged between the first lamination step and the third lamination step.

In addition to one or more of the features described herein the first lamination step is formed from a first plurality of laminations, the second lamination step is formed from a second plurality of laminations, and the third lamination step is formed from a third plurality of laminations.

In addition to one or more of the features described herein a stator winding extends about each of the first lamination step, the second lamination step, and the third lamination step and at least one additional step formed from a single lamination is arranged between the second lamination step and the stator winding.

In addition to one or more of the features described herein a slot opening defined between adjacent ones of the plurality of stator core segments, the slot opening having an axis that is off-set from a radius of the annular segment support member.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a side view of a vehicle including an axial flux motor having stator core segments, in accordance with a non-limiting example;

FIG. 2 is a partial cross-sectional view of an axial-flux motor including two rotors arranged on either side of a stator having stator core segments, in accordance with a non-limiting example;

FIG. 3 is a plan view of a stator including stator core segments, in accordance with a non-limiting example;

FIG. 4 is a perspective view of a stator core segment, in accordance with a non-limiting example;

FIG. 5 depicts a lamination stack of the stator core segment of FIG. 4, in accordance with a non-limiting example;

FIG. 6 depicts a first lamination step of the lamination stack of FIG. 5, in accordance with a non-limiting example;

FIG. 7 depicts a second lamination step of the lamination stack of FIG. 5, in accordance with a non-limiting example;

FIG. 8 depicts a stator core segment in accordance with another non-limiting example; and

FIG. 9 is a plan view of a stator including skewed stator core segments, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

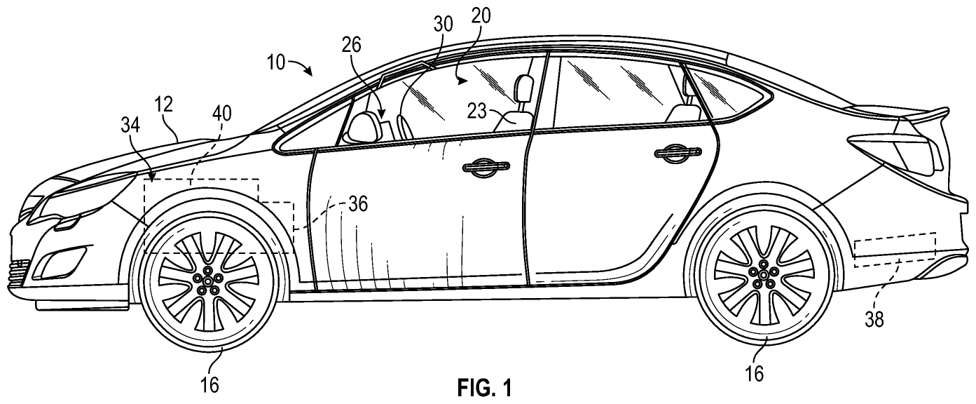

A vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. That is, changing a position of two of the plurality of wheels 16 relative to body 12 will cause vehicle 10 to change direction. Body 12 defines, in part, a passenger compartment 20 having seats 23 positioned behind a dashboard 26. A steering control 30 is arranged between seats 23 and dashboard 26. Steering control 30 is operated to control orientation of the steerable wheel(s).

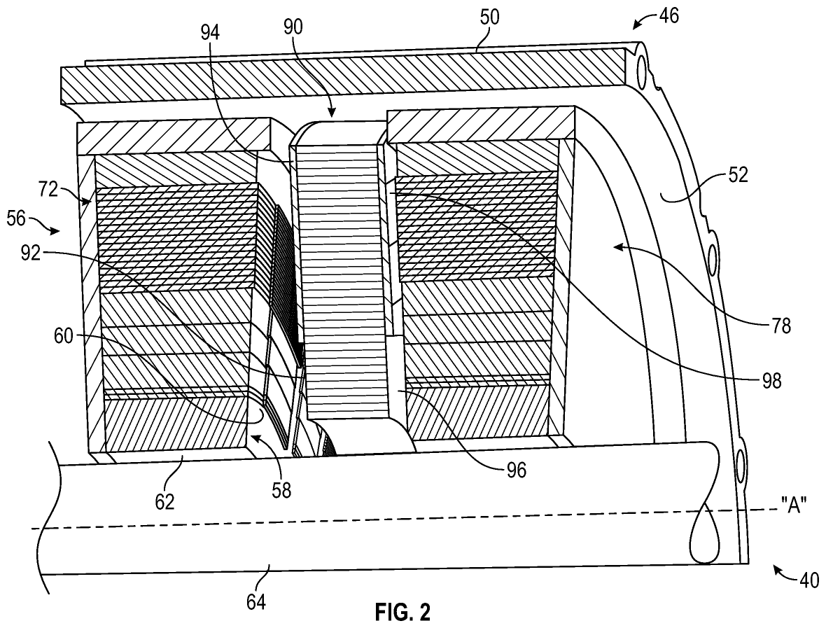

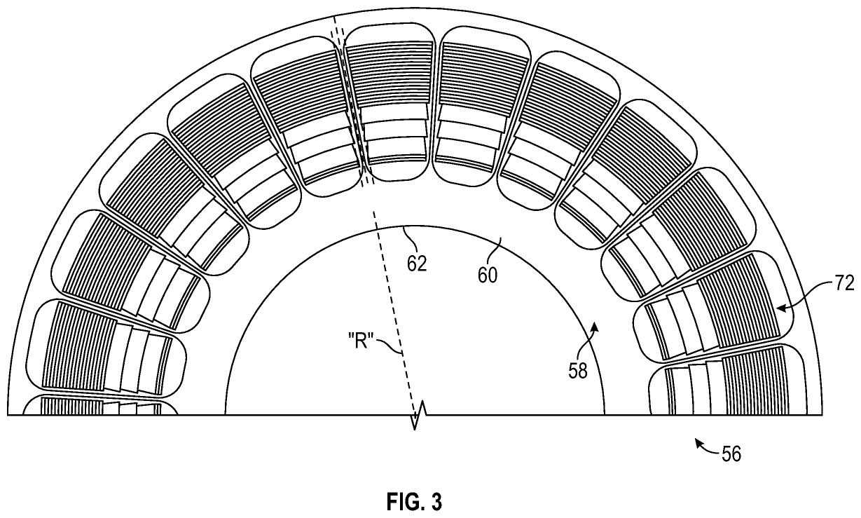

Vehicle 10 includes an electric motor 34 connected to a transmission 36 that provides power to one or more of the plurality of wheels 16. A rechargeable energy storage system (RESS) 38 provides power to electric motor 34. In a non-limiting example, electric motor 34 takes the form of an axial flux electric motor 40 having a housing 46 as shown in FIGS. 2 and 3. Housing 46 includes an outer surface 50 and an inner surface 52.

In a non-limiting example, a first stator 56 is fixedly mounted within housing 46. First stator 56 includes an annular segment support member 58 having a radius “R”. Annular segment support member 58 includes an axially facing surface 60 having a central opening 62 through which passes a shaft 64 having an axis of rotation “A”. A plurality of stator core segments, one of which is indicated at 72, is mounted to annular segment support member 58 and arrayed about axially facing surface 60. Axial flux electric motor 40 is shown to include a second stator 78 axially spaced from first stator 56. In a non-limiting example, first stator 56 and second stator 78 are similarly formed.

A rotor 90 is rotatably coupled to shaft 64 and disposed between first stator 56 and second stator 78. Rotor 90 includes a first axially facing surface 92 supporting a first plurality of permanent magnet members 94 and a second axially facing surface 96 supporting a second plurality of permanent magnet members 98. First and second pluralities of permanent magnet members 94 and 98 are rotated relative to first and second stators 56 and 78 to produce an electric current. At this point, it should be understood that while axial flux electric motor 40 is shown to include a rotor flanked by two stators, other arrangements are also contemplated such as a single stator flanked by first and second rotors.

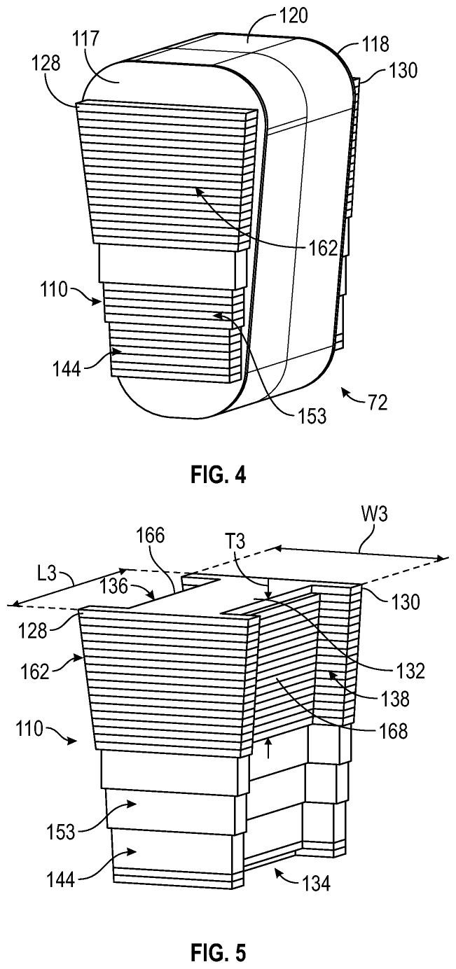

Reference will now follow to FIGS. 4 and 5 in describing one of stator core segments 72 with an understanding that remaining ones of stator core segments 72 as well as stator core segments (not separately labeled) on second stator 78 include similar structure. Each stator core segment 72 includes a plurality of laminations 110 that are stepped to form a substantially trapezoidal shape. A first slot liner 117 and a second slot liner 118 are spaced one from another and mounted to laminations 110. First and second slot liners 117 and 118 are electrically insulative. A core winding 120 is wound around laminations 110 between first and second slot liners 117 and 118.

As shown in FIG. 5, laminations 110 include a first axial end 128 and a second axial end 130 that are joined by a bridge portion 132 forming a tapered I-shaped member 134 including a first recess 136 and a second recess 138. First slot liner 117 is arranged at first axial end 128 and second slot liner 118 is arranged at second axial end 130. With this arrangement, core winding 120 extends about bridge portion 132 and resides in first recess 136 and second recess 138. As will be detailed herein, laminations 110 are formed from a plurality of lamination steps, several of which will be described herein, that form tapered I-shaped member 134.

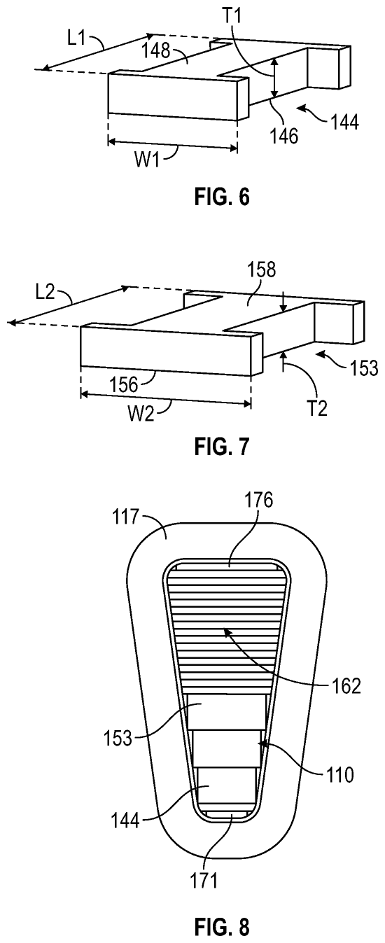

As shown in FIG. 6 and with continued reference to FIG. 5, laminations 110 include a first lamination step 144 having a first side 146 and a second side 148. First lamination step 144 has a first length L1, a first width W1, and a first lamination step thickness T1. In a non-limiting example, first lamination step 144 may be formed from multiple laminations, as shown in FIG. 4, or from a single lamination, as shown in FIG. 5. A second lamination step 153 having a first side section 156 and a second side section 158 is arranged radially outwardly of first lamination step 144. Second lamination step 153, as shown in FIG. 7, has a second length L2, a second width W2, and a second lamination step thickness T2. In a non-limiting example, second lamination step 153 may be formed from multiple laminations, as shown in FIG. 4, or from a single lamination, as shown in FIG. 5.

A third lamination step 162 is disposed radially outwardly of second lamination step 153. Third lamination step 162 includes a first side surface 166 and a second side surface 168. Third lamination step has a third length L3, a third width W3 that tapers in a radial direction, and a third lamination step thickness T3. In a non-limiting example, third lamination step 162 may be formed from multiple laminations, as shown in FIG. 8. Of course, third lamination step 162 may also be formed as a single lamination.

In a non-limiting example, the second width W2 of the second lamination step 153 is distinct from the first width W1 of the first lamination step 144. Further, the second width W2 of the second laminations step 153 is greater than the first width W1 of the first lamination step 144. In addition, the third width W3 of third lamination step 162 not only tapers but is also greater than the first width W1 and the second width W2 of the first and second laminations steps 144 and 153, respectively.

In accordance with a non-limiting example, first lamination step thickness T1 of first lamination step 144 and second lamination step thickness T2 of second lamination step 153 are substantially similar. Third lamination step thickness T3 of third lamination step 162 is greater than either of the first lamination step thickness T1 and the second lamination step thickness T2. Additional laminations steps such as shown at 171 and 176 may form part of laminations 110 as shown in FIG. 8. Additional lamination step(s) 171 are disposed radially inwardly of first lamination step 144 and additional laminations step(s) 176 are disposed radially outwardly of third lamination step 162 so as to form rounded corners for laminations 110 to avoid creating sharp bends in core winding 120. By creating steps in the laminations 110 torque ripple effects produced by stator 56 may be reduced.

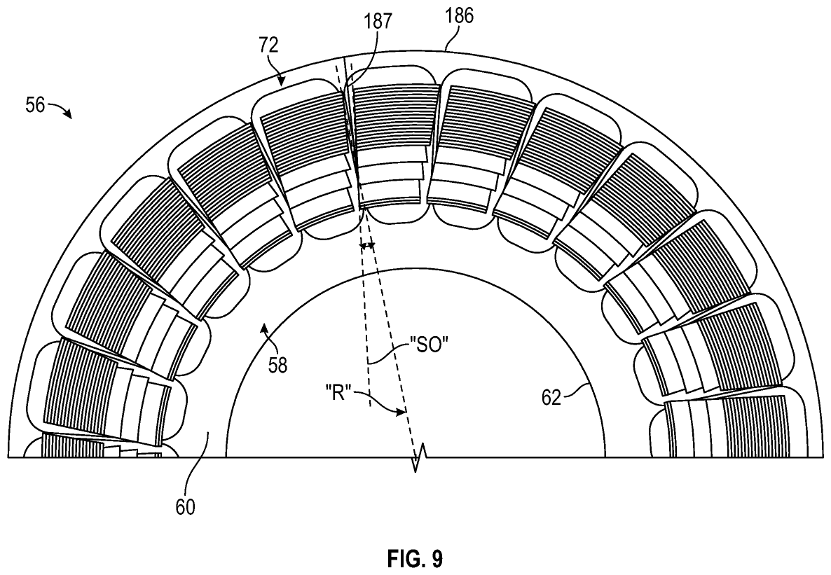

Reference will now follow to FIG. 9 in describing first stator 56 in accordance with another non-limiting example. In a non-limiting example, annular segment support member 58 includes a radius “R” that extends from an outer annular surface 186 to a center of an axis of rotation of shaft 64, FIG. 2. Each of the plurality of stator core segments 72 are spaced one from another on axially facing surface 60 by a slot opening 187 having a slot opening “SO” axis. Further, stator core segments 72 may be angled relative to radius “R” or constructed to skewed so as to create an off-set between SO axis and radius “R”. By creating the off-set between the SO axis either by skewing stator core segment 72 or by rotating stator core segment 72 on axially facing surface 60 torque ripple effects may be reduced.

At this point, it should be understood that varying dimensions of the laminations not only creates torque ripple reducing steps but also reduces the number of laminations needed to form a stator core segment. Further, by reducing stator lamination numbers, stator core segment construction is simplified. Further, the use of varying sized lamination members promotes the ability to skew lamination orientation in order to further reduce torque ripple effects.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A stator core segment for an axial flux electric motor comprising:
a first lamination step having a first length, a first width, and a first thickness; and
a second lamination step having a second length, a second width, and a second thickness, wherein at least one of the second length, the second width, and the second thickness is distinct from corresponding ones of the first length, the first width, and the first thickness.

2. The stator core segment according to claim 1, wherein the second width of each of the second lamination step is distinct from the first width of the first lamination step.

3. The stator core segment according to claim 2, wherein the second width of the second lamination step is smaller than the first width of the first lamination step.

4. The stator core segment according to claim 3, wherein the first lamination step includes a first lamination step thickness and the second lamination step includes a second laminations step thickness that is similar to the first lamination step thickness.

5. The stator core segment according to claim 4, further comprising a third lamination step having a third length, a third width that is greater than the first width, and a third thickness.

6. The stator core segment according to claim 5, wherein the third thickness is greater than the first thickness and the second thickness.

7. The stator core segment according to claim 5, wherein the second lamination step is arranged between the first lamination step and the third lamination step.

8. The stator core segment according to claim 5, wherein the first lamination step is formed from a first plurality of laminations, the second lamination step is formed from a second plurality of laminations, and the third lamination step is formed from a third plurality of laminations.

9. The stator core segment according to claim 5, further comprising a stator winding extending about each of the first lamination step, the second lamination step, and the third lamination step.

10. The stator core segment according to claim 9, further comprising at least one additional step formed from a single lamination arranged between the second lamination step and the stator winding.

11. A vehicle comprising:
a body defining a passenger compartment; and
an axial flux electric motor arranged in the body, the axial flux electric motor comprising:
a housing;
a rotor rotatably supported in the housing; and
a stator fixedly mounted in the housing, the stator including an annular segment support member having an axially facing surface and a plurality of stator core segments mounted about the axially facing surface, each of the plurality of stator core segments comprising:
a first lamination step having a first length, a first width, and a first thickness; and
a second lamination step having a second length, a second width, and a second thickness, wherein at least one of the second length, the second width, and the second thickness is distinct from corresponding ones of the first length, the first width, and the first thickness.

12. The vehicle according to claim 11, wherein the second width of each of the second lamination step is distinct from the first width of the first lamination step.

13. The vehicle according to claim 12, wherein the second width of the second lamination step is smaller than the first width of the first lamination step.

14. The vehicle according to claim 13, wherein the first lamination step includes a first lamination step thickness and the second lamination step includes a second laminations step thickness that is similar to the first lamination step thickness.

15. The vehicle according to claim 14, further comprising a third lamination step having a third length, a third width that is greater than the first width, and a third thickness.

16. The vehicle according to claim 15, wherein the third thickness is greater than the first thickness and the second thickness.

17. The vehicle according to claim 15, wherein the second lamination step is arranged between the first lamination step and the third lamination step.

18. The vehicle according to claim 15, wherein the first lamination step is formed from a first plurality of laminations, the second lamination step is formed from a second plurality of laminations, and the third lamination step is formed from a third plurality of laminations.

19. The vehicle according to claim 15, further comprising:
a stator winding extending about each of the first lamination step, the second lamination step, and the third lamination step; and
at least one additional step formed from a single lamination arranged between the second lamination step and the stator winding.

20. The vehicle according to claim 11, further comprising a slot opening defined between adjacent ones of the plurality of stator core segments, the slot opening having an axis that is off-set from a radius of the annular segment support member.
